(19) United States
(12) Patent Application Publication
(10) Pub. No.: US 2025/0045803 A1
(43) Pub. Date: Feb. 6, 2025

(54) METHOD AND SYSTEM FOR PROVIDING CONTENT SERVICE USING LARGE DISPLAY

(71) Applicant: DSTRICT HOLDINGS CO., LTD., Seoul (KR)

(72) Inventor: Sungho LEE, Seoul (KR)

(73) Assignee: DSTRICT HOLDINGS CO., LTD., Seoul (KR)

(21) Appl. No.: 18/718,338

(22) PCT Filed: Dec. 16, 2021
(86) PCT No.: PCT/KR2021/019231

§ 371 Date: Jun. 10, 2024

(51) Int. Cl. G06Q 30/0241; G06Q 30/0273

(52) U.S. Cl. CPC G06Q 30/0277; G06Q 30/0273

(57) ABSTRACT

Disclosed is a system and method for providing a content service using a large display. According to an embodiment, a content service providing method executed by a computer system may comprise the steps of: storing and maintaining a plurality of contents which can be reproduced before or after at least one advertisement reproduced on at least one large display; providing information related to the plurality of contents to at least one client; selecting at least one content from among the plurality of contents in response to a selection input of the at least one client, which is based on the information related to the plurality of contents; and providing the at least one client with a content service causing the selected at least one content to be reproduced on the at least one large display.

### TECHNICAL FIELD

The following example embodiments relate to technology for a system and method for providing a content service using a large display.

### RELATED ART

Among various forms of advertising, outdoor advertising refers to advertising that is provided through large billboards, installed on streets through which a large number of unspecific people pass or rooftops of buildings that are spaces in which passers-by may easily view. Such outdoor advertising is used as a useful advertising method in areas with large floating population.

Meanwhile, with the recent development of communication and electronic technology, the form of outdoor advertising is also changing in various ways. For example, in addition to the existing newspaper and television media, various media, for example, new media such as digital signage, are emerging. The digital signage refers to combination of various information technology (IT), such as hardware, software, content, and network, and represents a digital information display (DID) device that may output various types of information and advertisements, such as still images and videos. The existing digital signage related technology is disclosed in Korean Patent Laid-Open Publication No. 10-2016-0083719.

This kind of digital signage billboard is used to play back an advertisement indoors or outdoors based on a large display and may create revenues by playing back a set advertisement at a time desired by an advertiser and by charging the advertiser a service fee.

However, this large display-based digital signage billboard currently does not have anything suitable to play back during the rest of the day except for some hours in which advertisements are played back.

Therefore, there is a need to propose technology for providing content to play back at a time other than a time at which an advertisement is played back on the large display-based digital signage billboard.

### DETAILED DESCRIPTION

### Technical Subject

Example embodiments propose a method and system that provides a content service of allowing content including non-advertising information to be played back before or after an advertisement played back on a large display.

In more detail, example embodiments propose a method and system that provides a content service of providing information related to a plurality of contents to a client and allowing the client to select content to be played back on a large display, so that the selected content is inserted between advertisements played back on the large display and thereby played back.

Here, example embodiments propose a content service providing method and system that provides information to a client and receives a selection from the client through a preconstructed platform.

Also, example embodiments propose a content service providing method and system that charges a service fee for a content service as the content service is provided to a client.

Also, example embodiments propose a content service providing method and system that performs preprocessing for content to be played back on a large display.

Also, example embodiments propose a content service providing method and system that provides a recommendation service of recommending at least one content to a client and provides a search service for at least one content when providing information related to a plurality of contents to the client.

### Solution

According to an example embodiment, there is provided a content service providing method executed by a computer system, the content service providing method including storing and maintaining a plurality of contents playable back before or after at least one advertisement played back on at least one large display; providing information related to the plurality of contents to at least one client; selecting at least one content from among the plurality of contents in response to a selection input from the at least one client based on information related to the plurality of contents; and providing a content service of allowing the selected at least one content to be played back on the at least one large display to the at least one client.

According to an aspect, the maintaining and the storing of the plurality of contents may include constructing and updating a platform that provides information related to the plurality of contents, and the providing of information related to the plurality of contents to the at least one client may include allowing the at least one client to access the platform.

According to another aspect, the selecting of the at least one content from among the plurality of contents may include selecting the at least one content in response to the selection input from the at least one client on the at least one content generated on the platform.

According to still another aspect, the content service providing method may further include providing an operating service of managing the at least one large display to the at least one client or an administrator that manages the at least one large display through the platform.

According to still another aspect, the providing of the content service to the at least one client may further include charging the at least one client a service fee for the content service based on playback information including a point in time, the number of times, a time, and a period related to playback of the at least one content on the at least one large display.

According to still another aspect, the charging of the service fee for the content service may include charging the at least one client the service fee for the content service further based on information related to playback of the at least one advertisement on the at least one large display, hardware information of the at least one large display, and location information of the at least one large display.

According to still another aspect, information related to playback of the at least one advertisement on the at least one large display may include information related to an attribute of the at least one advertisement played back on the at least one large display, a point in time and a time at which the at least one advertisement is played back on the at least one large display, and a service fee for the at least one advertisement played back on the at least one large display.

According to still another aspect, the location information of the at least one large display may include information related to a geographical location of the at least one large display and surrounding context of the at least one large display by the geographical location.

According to still another aspect, the charging of the service fee for the content service may further include paying at least a portion of the charged service fee to a creator of the at least one content.

According to still another aspect, the charging of the service fee for the content service may further include paying at least a portion of the charged service fee to a building owner of a building in which the at least one large display is installed when the at least one client is an advertiser of the at least one advertisement.

According to still another aspect, the content service providing method may further include performing preprocessing for playing back the selected at least one content on the at least one large display, prior to providing the content service to the at least one client.

According to still another aspect, the performing of the preprocessing may include setting playback information that includes information on a point in time, a brightness, a feeling of color, a time, a speed, a volume, and a playback size related to playback of the selected at least one content.

According to still another aspect, the setting of the playback information may include setting the playback information based on information related to playback of the at least one advertisement on the at least one large display, hardware information of the at least one large display, or location information of the at least one large display.

According to an example embodiment, there is provided a computer program recorded on a computer-readable recording medium to execute a content service providing method in conjunction with a computer system, wherein the content service providing method includes storing and maintaining a plurality of contents playable back before or after at least one advertisement played back on at least one large display; providing information related to the plurality of contents to at least one client; selecting at least one content from among the plurality of contents in response to a selection input from the at least one client based on information related to the plurality of contents; and providing a content service of allowing the selected at least one content to be played back on the at least one large display to the at least one client.

According to an example embodiment, there is provided a content service providing system implemented as a computer system, the content service providing system including processor configured to execute computer-readable instructions, wherein the at least one processor includes a platform provider configured to store and maintain a plurality of contents playable back before or after at least one advertisement played back on at least one large display, and to provide information related to the plurality of contents to at least one client; a content selector configured to select at least one content from among the plurality of contents in response to a selection input from the at least one client based on information related to the plurality of contents; and a content service provider configured to provide a content service of allowing the selected at least one content to be played back on the at least one large display to the at least one client.

### Effect

According to example embodiments, it is possible to propose a method and system that provides a content service of allowing content including non-advertising information to be played back before or after an advertisement played back on a large display.

In more detail, according to example embodiments, it is possible to propose a method and system that provides a content service of providing information related to a plurality of contents to a client and allowing the client to select content to be played back on a large display, so that the selected content is inserted between advertisements played back on the large display and thereby played back.

Here, according to example embodiments, it is possible to propose a content service providing method and system that provides information to a client and receives a selection from the client through a preconstructed platform.

Also, according to example embodiments, it is possible to propose a content service providing method and system that charges a service fee for a content service as the content service is provided to a client.

Also, according to example embodiments, it is possible to propose a content service providing method and system that performs preprocessing for content to be played back on a large display.

Also, according to example embodiments, it is possible to propose a content service providing method and system that provides a recommendation service of recommending at least one content to a client and provides a search service for at least one content when providing information related to a plurality of contents to the client.

### BRIEF DESCRIPTION OF DRAWINGS

FIG. 1 is a conceptual diagram for describing a content service providing method according to an example embodiment.

FIG. 2 is a diagram illustrating an example of a content service providing system environment according to an example embodiment.

FIG. 3 is a block diagram illustrating an internal configuration of an electronic device and a server according to an example embodiment.

FIG. 4 is a block diagram illustrating an example of a component includable in a processor of a server according to an example embodiment.

FIG. 5 is a flowchart illustrating a content service providing method according to an example embodiment.

FIG. 6 is a conceptual diagram for describing a platform used in a content service providing method according to an example embodiment.

FIGS. 7A and 7B illustrate an operation of recommending content and an operation of providing a search service for content in a content service providing method according to an example embodiment.

FIGS. 8A to 8C illustrate an operation of performing preprocessing in a content service providing method according to an example embodiment.

FIGS. 9A and 9B illustrate examples of content played back on a large display when a content service is provided according to an example embodiment.

FIG. 10 illustrates a factor that affects in determining a service fee in an operation of charging a service fee in a content service providing method according to an example embodiment.

FIG. 11 illustrates an operation of distributing a service fee in a content service providing method according to an example embodiment.

### BEST MODE

Hereinafter, example embodiments will be described in detail with reference to the accompanying drawings. However, the present invention is not limited to or restricted by the example embodiments. Also, like reference numerals presented in the respective drawings refer to like elements.

Also, terms (terminology) used herein refer to terms used to appropriately explain example embodiments of the present invention, which may vary depending on a user, the intent of an operator, or custom to which the present invention pertains. Therefore, the definition of the terms should be made based on the overall content of the present specification.

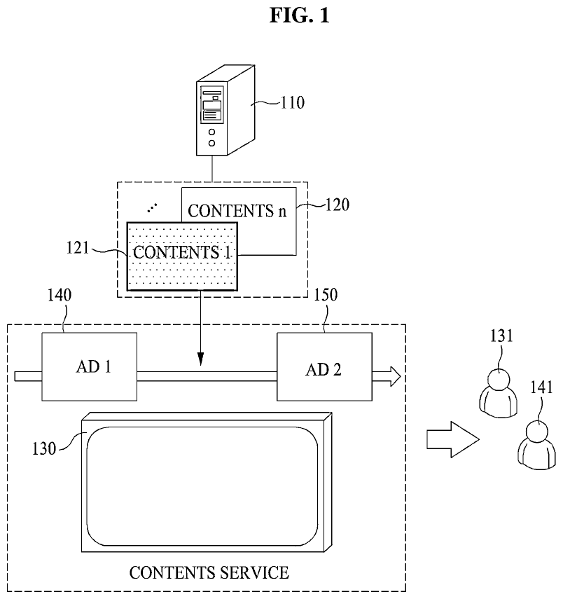

FIG. 1 is a conceptual diagram for describing a content service providing method according to an example embodiment.

Referring to FIG. 1, the content service providing method according to an example embodiment may include an operation in which a content service providing system 110 provides a content service (content service representing a service of allowing at least one content 121 to be played back before or after at least one advertisement 140 played back on at least one large display 130) to at least one client 131, 141 and preliminary operations for the operation (operation of providing information related to a plurality of contents 120 to the at least one client 131, 141 so that the at least one client 131, 141 selects the at least one content 121 to be played back before or after the at least one advertisement 140 played back on the at least one large display 130). Therefore, all the following description in which the content service providing method is a main entity may represent that it is executed by the content service providing system 110.

Hereinafter, each of the plurality of contents 120 including the at least one content 121 includes non-advertising information, which differs from the at least one advertisement 140 including advertising information, and may represent content with intellectual property (IP).

Also, in the following, that the at least one content 121 is played back before or after the at least one advertisement 140 played back on the at least one large display 130 may represent that the at least one content 121 is played back at a point in time before or after a point in time at which the at least one advertisement 140 is played back on the at least one large display 130 (accurately, a point in time after a playback time of the at least one advertisement 140 elapses from a point in time at which the at least one advertisement 140 is played back on the at least one large display 130). Also, that the at least one content 121 is played back before or after the at least one advertisement 140 played back on the at least one large display 130 may represent that the at least one content 121 is inserted and thereby played back between advertisements 140 and 150 played back on the at least one large display 130. Also, that the at least one content 121 is inserted and played back between the advertisements 140 and 150 played back on the at least one large display 130 may represent that the at least one content 121 is played back at a point in time between points in times at which the advertisements 140 and 150 are played back on the at least one large display 130, respectively.

Also, in the following, the at least one large display 130 refers to a display device, such as a plasma display panel (PDP), a liquid crystal display (LCD), or a light emitting diode (LED) for indoor advertising or outdoor advertising, and may represent a display device provided inside or outside various types of facilities, such as a building, and having a size of greater than or equal to a predetermined reference (e.g., size of more than 8 m width*4 m length).

Also, in the following, the at least one client 131, 141 may represent a user that is provided with the content service to play back the at least one content 121 including non-advertising information through the at least one large display 130. For example, the at least one client 131, 141 may be a building owner of a building in which the at least one large display 130 is installed or an advertiser for the at least one advertisement 140 played back through the at least one large display 130.

In particular, the content service providing method may provide information related to the plurality of contents 120 to the at least one client 131, 141 and may receive a selection input on the at least one content 121 to be played back through the at least one large display 130 among the plurality of contents 120 from the at least one client 131, 141 through a preconstructed platform, thereby improving the convenience for the at least one client 131, 141 to use the content service.

Also, the content service providing method may propose a model of creating new revenues in addition to revenues as the at least one advertisement 140 is played back by performing an operation of charging a service fee for the content service as the content service is provided to the at least one client 131, 141.

In particular, the content service providing method may perform preprocessing for playing back the at least one content 121 on the at least one large display 130, thereby maximizing the effect coming from the at least one content 121 being played back on the at least one large display 130.

Also, when providing information related to the plurality of contents 120 to the at least one client 131, 141, the content service providing method may provide a recommendation service of recommending the at least one content 121 and a search service for the at least one content 121, thereby encouraging the effect of providing the customized content service.

Hereinafter, specific example embodiments of an environment in which the content service providing system 110 performs the content service providing method are described.

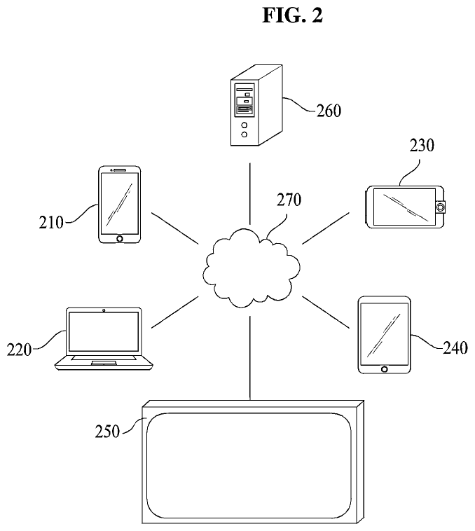

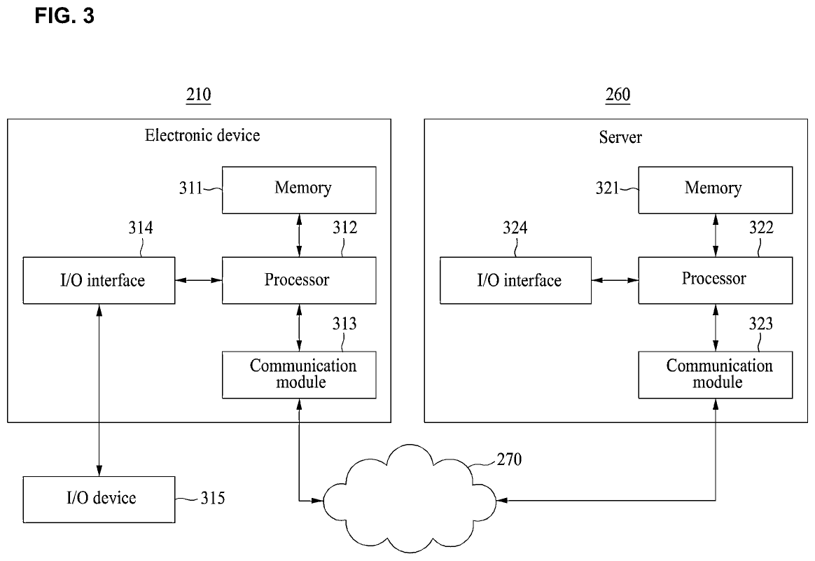

FIG. 2 is a diagram illustrating an example of a content service providing system environment according to an example embodiment, and FIG. 3 is a block diagram illustrating an internal configuration of an electronic device and a server according to an example embodiment.

The content service providing system environment of FIG. 2 represents an example of including a plurality of electronic devices 210, 220, 230, and 240, at least one large display 250, a server 260, and a network 270. FIG. 2 is provided as an example only and the number of electronic devices or the number of servers is not limited to FIG. 2.

Each of the plurality of electronic devices 210, 220, 230, and 240 refers to a mobile or fixed terminal implemented as a computer device and may represent a terminal carried by at least one client to which a content service is provided. Examples of the plurality of electronic devices 210, 220, 230, and 240 may include a smartphone, a mobile phone, a tablet personal computer (PC), a navigation device, a computer, a laptop computer, a digital broadcasting terminal, a personal digital assistant (PDA), a portable multimedia player (PMP), and a user wearable device. For example, the first electronic device 210 may communicate with other electronic devices 220, 230, and 240, the at least one large display 250, and/or the server 260 over the network 270 using a wireless or wired communication scheme.

The communication scheme is not limited and may include a near field wireless communication scheme between devices as well as a communication scheme using a communication network (e.g., a mobile communication network, wired Internet, wireless Internet, and a broadcasting network) includable in the network 270. For example, the network 270 may include at least one network among networks that include a personal area network (PAN), a local area network (LAN), a campus area network (CAN), a metropolitan area network (MAN), a wide area network (WAN), a broadband network (BBN), and the Internet. Also, the network 270 may include at least one of network topologies that include a bus network, a star network, a ring network, a mesh network, a star-bus network, a tree or hierarchical network, and the like. However, they are provided as examples only.

The server 260 may be implemented as a computer device or a plurality of computer devices that provides an instruction, a code, a file, content, and a service, through communication with the plurality of electronic devices 210, 220, 230, and 240 and the at least one large display 250 over the network 270.

For example, the server 260 may provide a file related to installation of an application for being provided with a content service to the first electronic device 210 connected over the network 270. In this case, the first electronic device 210 may install the application using the file provided from the server 260. Also, the first electronic device 210 may receive a service or content provided from the server 260 through connection to the server 260 under control of an operating system (OS) or at least one program (e.g., browser or the installed application) included in the first electronic device 210. For example, when the first electronic device 210 sends a service request message to the server 260 over the network 270 under control of the application, the server 260 may send a code corresponding to the service request message to the first electronic device 210 and the first electronic device 210 may provide the content to a user by configuring and display a screen according to the code under control of the application.

In FIG. 3, an internal configuration of the first electronic device 210 is described as an example for a single electronic device that is a terminal carried by the user and an internal configuration of the server 260 is described as an example for a single server that communicates with a terminal of a client. Therefore, in the following, the first electronic device 210 may represent a terminal of at least one client that is provided with a content service and the server 260 may represent an entity server that provides the content service by communicating with the at least one large display 250 and the terminal of at least one client. Other electronic devices 220, 230, and 240 or the at least one large display 250 may also have the same or similar internal configuration.

The first electronic device 210 and the server 260 may include memories 311 and 321, processors 312 and 322, communication modules 313 and 323, and input/output (I/O) interfaces 314 and 324, respectively. The memory 311, 321 may include a permanent mass storage device, such as a random access memory (RAM), a read only memory (ROM), and a disk drive, as a computer-readable recording medium. Also, an OS or at least one program code (e.g., code for an application installed and running on the first electronic device 210) may be stored in the memory 311, 321. Such software components may be loaded to the memory 311, 321 from another computer-readable recording medium separate from the memory 311, 321. The other computer-readable recording medium may include a computer-readable recording medium, for example, a floppy drive, a disk, a tape, a DVD/CD-ROM drive, a memory card, etc. According to other example embodiments, software components may be loaded to the memory 311, 321 through the communication module 313, 323, instead of the computer-readable recording medium. For example, at least one program may be loaded to the memory 311, 321 based on a program (e.g., the aforementioned application) installed by files provided through the network 270 by developers or a file distribution system (e.g., server different from the server 260) that distributes the installation file of the application.

The processor 312, 322 may be configured to process instructions of a computer program by performing basic arithmetic operations, logic operations, and I/O operations. The computer-readable instructions may be provided from the memory 311, 321 or the communication module 313, 323 to the processor 312, 322. For example, the processor 312, 322 may be configured to execute received instructions in response to the program code stored in the storage device, such as the memory 311, 321.

The communication module 313, 323 may provide a function for communication between the first electronic device 210 and the server 260 or a function for communication with the at least one large display 250 over the network 270 and may provide a function for communication with another electronic device (e.g., second electronic device 220) or another server. For example, a request (e.g., content service use request) created by the processor 312 of the first electronic device 210 based on a program code stored in a recording device, such as the memory 311, may be delivered to the server 260 over the network 270 under control of the communication module 313. Inversely, a control signal or an instruction, content, a file, etc., provided under control of the processor 322 of the server 260 may be received at the first electronic device 210 through the communication module 323, the network 270, and the communication module 313 of the first electronic device 210. For example, a control signal or an instruction of the server 260 received through the communication module 313 may be delivered to the processor 312 or the memory 311, and content or a file may be stored in a storage medium further includable in the first electronic device 210.

The I/O interface 314 may be a device used for interfacing with an I/O device 315. For example, an input device may include a device, such as a keyboard, a mouse, etc., and an output device may include a device, such as a display, for displaying a communication session of the application. As another example, the I/O interface 314 may be a device for interfacing with an apparatus in which an input function and an output function are integrated into a single function, such as a touchscreen. As a specific example, when the processor 312 of the first electronic device 210 processes an instruction of a computer program loaded to the memory 311, a service screen or content configured using data provided from the server 260 may be displayed on a display through the I/O interface 314. Likewise, when the processor 322 of the server 260 processes an instruction of a computer program loaded to the memory 321, the I/O interface 324 may also output information configured using data provided from the server 260.

Also, according to other example embodiments, the first electronic device 210 and the server 260 may include the number of components greater than or less than the number of components shown in FIG. 3. However, there is no need to clearly illustrate many components according to the related art. For example, the first electronic device 210 may include at least a portion of the I/O device 315, or may further include other components, for example, a transceiver, a global positioning system (GPS) module, a camera, various sensors, and a database. As a specific example, when the first electronic device 210 is a smartphone, the first electronic device 210 may be implemented to further include various components, such as an azimuth sensor, an acceleration sensor or a gyro sensor, a camera, various physical buttons, a button using a touch panel, an I/O port, and a vibrator for vibration, which are generally included in the smartphone.

Although the components of the first electronic device 210 and the server 260 are described above, components of the at least one large display 250 may also have the same structure.

Hereinafter, example embodiments of a content service providing method and system are described.

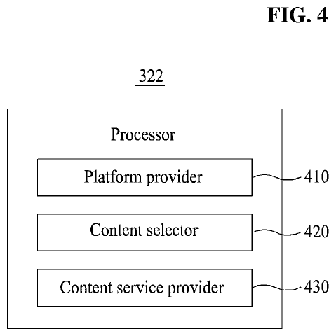

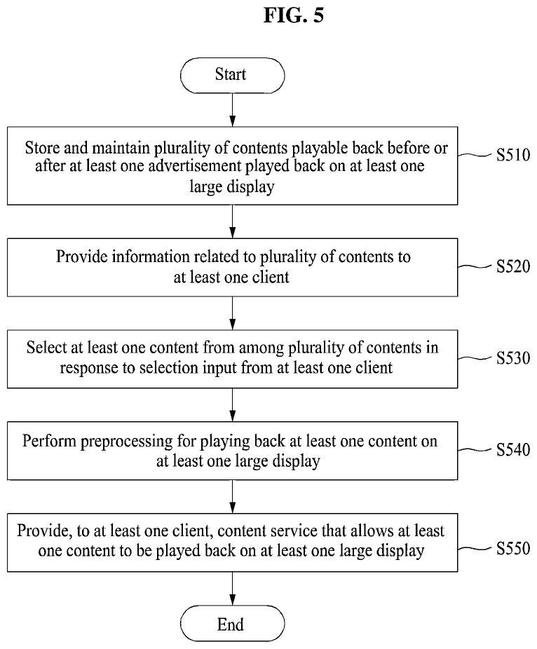

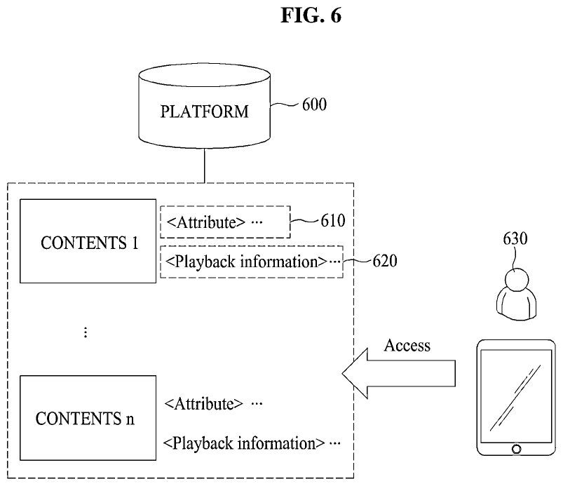

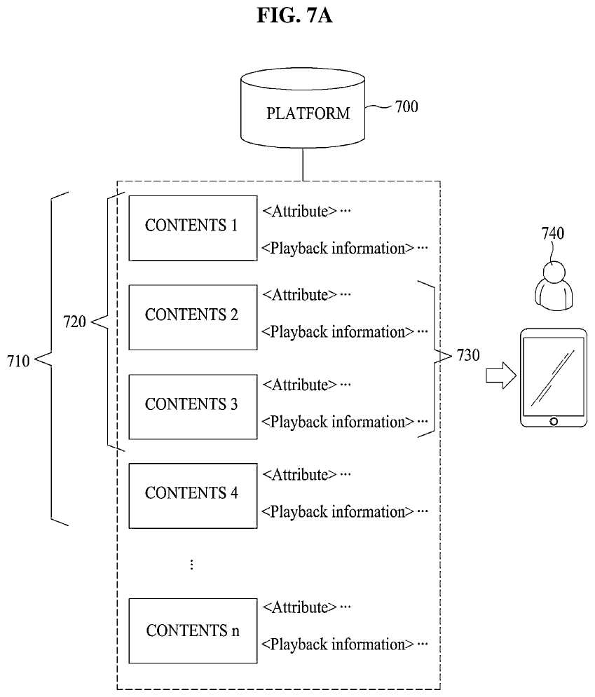

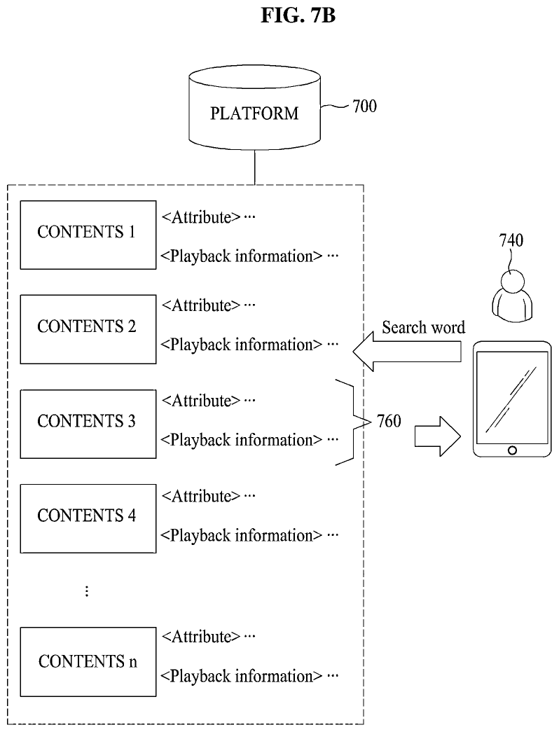

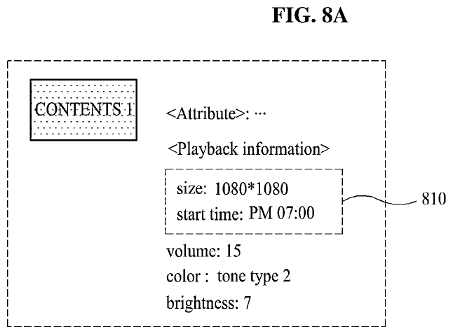

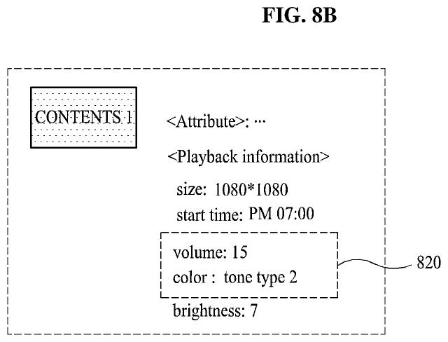

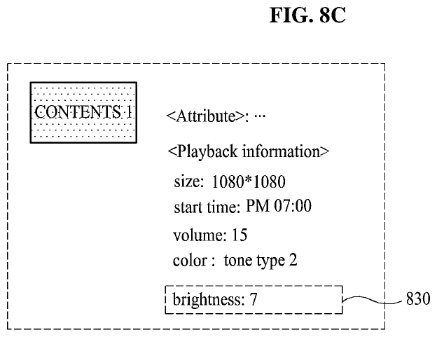

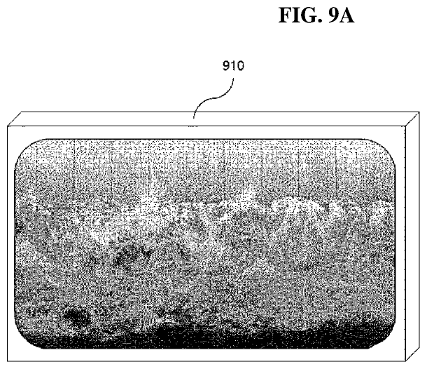

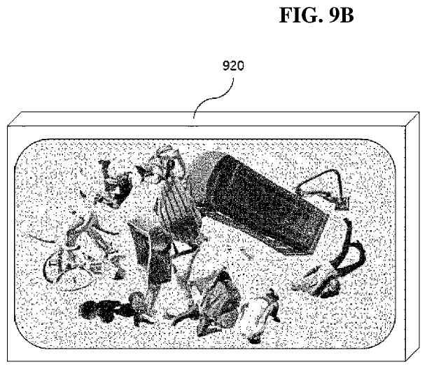

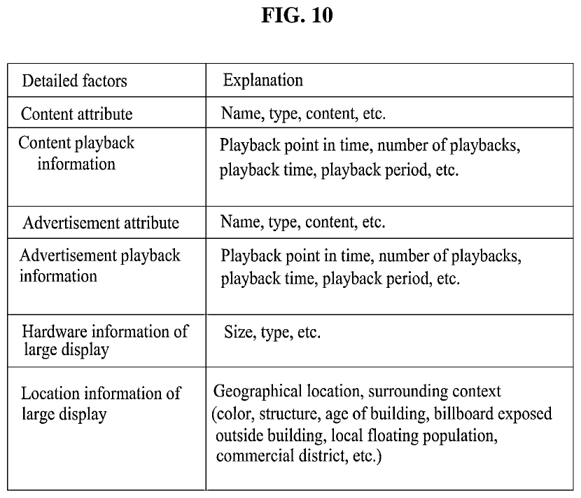

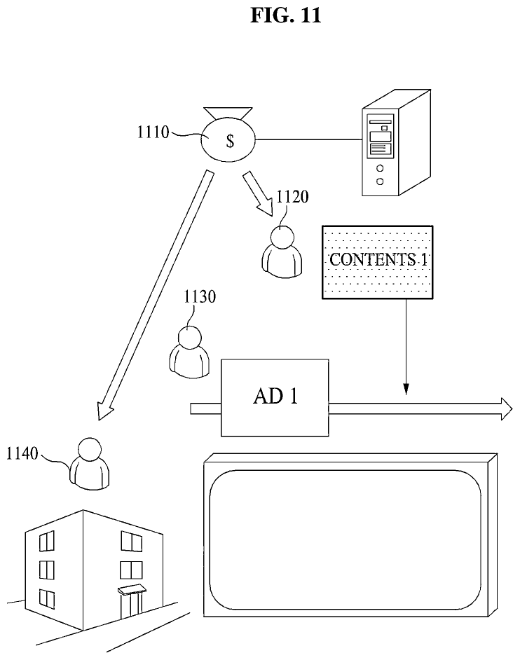

FIG. 4 is a block diagram illustrating an example of a component includable in a processor of a server according to an example embodiment, FIG. 5 is a flowchart illustrating a content service providing method according to an example embodiment, FIG. 6 is a conceptual diagram for describing a platform used in a content service providing method according to an example embodiment, FIGS. 7A and 7B illustrate an operation of recommending content and an operation of providing a search service for content in a content service providing method according to an example embodiment, FIGS. 8A to 8C illustrate an operation of performing preprocessing in a content service providing method according to an example embodiment, FIGS. 9A and 9B illustrate examples of content played back on a large display when a content service is provided according to an example embodiment, FIG. 10 illustrates a factor that affects in determining a service fee in an operation of charging a service fee in a content service providing method according to an example embodiment, and FIG. 11 illustrates an operation of distributing a service fee in a content service providing method according to an example embodiment.

A computer-implemented content service providing system may be configured in a server as described above with reference to FIGS. 2 and 3. The server refers to an entity that performs the content service providing method for a plurality of electronic devices as described above with reference to FIGS. 2 and 3, which are clients, and may perform the content service providing method corresponding to a service request through connection to a website/mobile site related to the server or a dedicated application installed on the plurality of electronic devices. In more detail, the server may perform the content service providing method that provides, to at least one client, a content service for allowing at least one content to be played back before or after at least one advertisement played back on at least one large display.

For the server to perform the content service providing method of FIG. 5, a processor of the server may include a platform provider 410, a content selector 420, and a content service provider 430 as shown in FIG. 4, as components. Depending on example embodiments, the components of the processor of the server may be selectively included in or excluded from the processor of the server. Also, depending on example embodiments, the components of the processor of the server may be separated or merged for functional expression of the processor. For example, at least some of the components of the processor of the server may be implemented in a processor included in an electronic device carried by at least one client or a processor included in at least one large display.

The components of the processor may control the server to perform operations S510 to S550 included in the content service providing method of FIG. 5. For example, the components of the processor may be implemented to execute an instruction according to a code of at least one program and a code of an OS included in a memory included in the server.

Here, the components of the processor may be expressions of different functions performed by the processor in response to an instruction provided from a program code stored in the server. For example, the content selector 420 may be used as a functional expression of the processor to select at least one content from among a plurality of contents.

The content service providing system including the platform provider 410, the content selector 420, and the content service provider 430 and an operation of the content service providing system are described below with reference to FIG. 5.

Before operation S510, the processor of the server may read a necessary instruction from the memory of the server to which instructions related to control of the server are loaded (not illustrated as a separate operation in drawings). In this case, the read instruction may include an instruction used for controlling the processor to execute the following operations S510 to S550.

The platform provider 410 may store and maintain a plurality of contents playable back before or after at least one advertisement played back on at least one large display in operation S510 and accordingly, may provide information related to the plurality of contents to at least one client in operation S520.

In particular, the platform provider 410 may store and maintain the plurality of contents by constructing and updating a platform that provides information related to the plurality of contents and may provide information related to the plurality of contents to the at least one client by allowing the at least one client to access the platform in response to a content service request from the at least one client.

For example, referring to FIG. 6, the platform provider 410 may store and maintain a plurality of contents by pre-constructing and updating a platform 600 that displays an attribute 610 of each of the plurality of contents configured as non-advertising information (hereinafter, attribute of content representing information on name, type, and content of the content) and playback information (information on playback time, point in time, speed, volume, playback size, brightness, feeling of color, and number of times) 620. Therefore, the platform provider 410 may provide information related to the plurality of contents to at least one client 630 by allowing the at least one client 630 to access the platform 600 in response to a content service request from the at least one client 630.

Also, in operation S520, the platform provider 410 may provide a recommendation service of recommending at least one content to the at least one client and a search service for the at least one content. Hereinafter, although it is described that the recommendation service and the search service are provided to the at least one client based on the aforementioned platform, it is provided as an example only.

In more detail, the platform provider 410 may recommend at least one content among the plurality of contents to the at least one client based on information related to the plurality of contents, information related to playback of the at least one advertisement on at least one the large display, hardware information of the at least one large display, or location information of the at least one large display.

Here, information related to the plurality of contents may include attribute and playback information of each of the plurality of contents, information related to playback of the at least one advertisement on the at least one large display may include an attribute of the at least one advertisement played back on the at least one large display (information on name, type, and content of the at least one advertisement) and playback information of the at least one advertisement (information on playback time, point in time, speed, volume, playback size, brightness, feeling of color, and the number of times related to playback of the at least one advertisement), the hardware information of the at least one large display may include information related to a size and a type of the at least one large display, and the location information of the at least one large display may include information related to a geographical location of the at least one large display and a surrounding context of the at least one large display by the geographical location (surrounding context of the at least one large display representing all information on things present around the at least one large display and environmental information, and including information on structure, color, and age of building in which the at least one large display is located, billboard exposed outside the building, local floating population, and commercial district).

For example, as shown in FIG. 7A, the platform provider 410 may primarily select contents 710 having a playback size suitable for a size of at least one large display from among a plurality of contents on a platform 700, may secondarily select contents 720 with a feeling of color suitable for being played back at PM 07:00, a point in time after a corresponding point in time at which at least one advertisement is played back on at least one large display from among the primarily selected contents 710, may tertiarily select contents 730 with content suitable for the city center of Seoul in which at least one large display is located from among the secondarily selected contents 720, and may recommend the same as candidate contents 730 to at least one client 740.

As another example, the platform provider 410 may store information related to the plurality of contents in a database using keywords and may output at least one content 760 having a keyword matched to a search word 750 input from the at least one client 740 as search results through the platform 700 as shown in FIG. 7B.

Also, although not illustrated as a separate operation, the platform provider 410 may provide an operating service of managing at least one large display to at least one client, an administrator that manages the at least one large display, or a building owner of a building in which the at least one large display is installed through the aforementioned platform. Here, the operating service of managing at least one large display may include a service of controlling at least one content to be played back on at least one large display as content service providing results described blow, a service of controlling at least one advertisement to be played back on at least one large display, and a service of controlling at least one large display itself.

In operation S530, the content selector 420 may select at least one content from among the plurality of contents in response to a selection input from the at least one client based on information related to the plurality of contents. Here, in operation S530, the content selector 420 may select at least one content in response to a selection input from the at least one client on at least one content generated on the aforementioned platform.

For example, when at least one client generates a selection input on at least one content among the plurality of contents on the platform 600 by referring to the attribute 610 of each of the plurality of contents and the playback information 620 displayed on the platform 600 of FIG. 6, the content selector 420 may recognize the selection input from the at least one client on the at least one content and may select the corresponding at least one content.

In operation S540, the content service provider 430 may perform preprocessing for playing back the selected at least one content on the at least one large display. In detail, in operation S540, the content service provider 430 may perform preprocessing of setting playback information that includes information on a point in time, a brightness, a feeling of color, a time, a speed, a volume, a playback size, and the number of times related to playback of the selected at least one content.

Here, setting the playback information may be performed based on request information (e.g., content playback request time, content playback iteration time, etc.) of at least one content having caused the selection input on the at least one content and may also be performed based on information related to playback of the at least one advertisement on the at least one large display, hardware information of the at least one large display, or the location information of the at least one large display.

Here, information related to playback of the at least one advertisement on the at least one large display may include an attribute of at least one advertisement played back on the at least one large display (information on name, type, and content of the at least one advertisement) and playback information of the at least one advertisement (information on playback time, point in time, speed, volume, playback size, brightness, feeling of color, and the number of times related to playback of the at least one advertisement), the hardware information of the at least one large display may include information related to a size and a type of the at least one large display, and the location information of the at least one large display may include information related to a geographical location of the at least one large display and a surrounding context of the at least one large display by the geographical location (surrounding context of the at least one large display representing all information on things present around the at least one large display and environmental information, and including information on structure, color, and age of building in which the at least one large display is located, billboard exposed outside the building, local floating population, and commercial district).

For example, as shown in FIG. 8A, the content service provider 430 may set playback information 810 of at least one content so that the at least one content has a playback size suitable for a size of at least one large display and plays back at PM 07:00 that is a point in time after a point in time at which at least one advertisement is played back on the at least one large display.

As another example, as shown in FIG. 8B, the content service provider 430 may set playback information 820 of at least one content so that the at least one content has a volume of a preset value or more in consideration of noise in downtown Seoul in which at least one large display is present and has a feeling of color similar to that of at least one advertisement previously played back.

As another example, as shown in FIG. 8C, the content service provider 430 may set playback information 830 of at least one content so that the at least one content has a brightness of a preset value or less in consideration of complexity of billboards on exterior walls of a building in which at least one large display is installed.

Then, in operation S550, the content service provider 430 may provide a content service of playing back the preprocessed at least one content on the at least one large display to the at least one client. In more detail, the content service provider 430 may provide, to the at least one client, the content service that allows the at least one content to be played back on the at least one large display according to the playback information set in operation S540.

For example, as a result of performing operations S510 to S550 through the content service provider 430, the content service that allows realistic content to be played back on at least one large display 910 or 920 may be provided to at least one client as shown in FIG. 9A or 9B.

Here, in operation S550, the content service provider 430 may charge a service fee for the content service to the at least one client. In detail, the content service provider 430 may charge the service fee for the content service to the at least one client based on playback information including information related to a point in time, the number of times, a time, and a period related to playback of at least one content on the at least one large display.

For example, the more the number of times, the longer a time, and the longer a period related to playback of the at least one content, and the closer a playback point in time is to a point in time with large floating population, the more a service usage fee may be charged.

Also, the content service provider 430 may charge the service fee for the content service to the at least one client further based on information related to playback of the at least one advertisement on the at least one large display, hardware information of the at least one large display, and location information of the at least one large display, in addition to playback information of the at least one content.

Here, information related to playback of the at least one advertisement on the at least one large display may include an attribute of at least one advertisement played back on the at least one large display (information on name, type, and content of the at least one advertisement), playback information of the at least one advertisement (information related to playback time, point in time, speed, volume, playback size, brightness, feeling of color, and the number of times related to playback of the at least one advertisement), and information related to a service fee for playing back the at least one advertisement on the at least one large display, the hardware information of the at least one large display may include information related to a size and a type of the at least one large display, and the location information of the at least one large display may include information related to a geographical location of the at least one large display and a surrounding context of the at least one large display by the geographical location (surrounding context of the at least one large display representing all information on things present around the at least one large display and environmental information, and including information on structure, color, and age of building in which the at least one large display is located, billboard exposed outside the building, local floating population, and commercial district).

Factors that affect setting a service fee in a charging operation of the content service provider 430 may be explained with a table shown in FIG. 10.

Also, at the same time of charging the service fee for the content service to the at least one client in operation S550, the content service provider 430 may pay at least a portion of a service fee 1110 charged as shown in FIG. 11 to a creator 1120 of the at least one content. In this case, an amount paid to the creator 1120 may be determined according to a preset ratio based on the service fee 1110, or may be computed using a factor that affects determining the service fee 1110.

Also, when the at least one client is an advertiser 1130 of the at least one advertisement, the content service provider 430 may pay at least a portion of the charged service fee 1110 even to a building owner 1140 of a building in which the at least one large display is installed as shown in FIG. 11. Likewise, an amount paid to the building owner 1140 may be determined according to a preset ratio based on the service fee 1110, or may be computed using a factor that affects determining the service fee 1110.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the example embodiments may be configured in a form of program instructions performed through various computer methods and recorded in computer-readable media. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of other media may include record media and storage media managed by an app store that distributes applications or a site that supplies and distributes other various types of software, a server, and the like.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A content service providing method executed by a computer system, the content service providing method comprising:
storing and maintaining a plurality of contents playable back before or after at least one advertisement played back on at least one large display;
providing information related to the plurality of contents to at least one client;
selecting at least one content from among the plurality of contents in response to a selection input from the at least one client based on information related to the plurality of contents; and
providing a content service of allowing the selected at least one content to be played back on the at least one large display to the at least one client.

2. The content service providing method of claim 1, wherein the maintaining and the storing of the plurality of contents comprises constructing and updating a platform that provides information related to the plurality of contents, and
the providing of information related to the plurality of contents to the at least one client comprises allowing the at least one client to access the platform.

3. The content service providing method of claim 2, wherein the selecting of the at least one content from among the plurality of contents comprises selecting the at least one content in response to the selection input from the at least one client on the at least one content generated on the platform.

4. The content service providing method of claim 2, further comprising:
providing an operating service of managing the at least one large display to the at least one client or an administrator that manages the at least one large display through the platform.

5. The content service providing method of claim 1, wherein the providing of the content service to the at least one client further comprises charging the at least one client a service fee for the content service based on playback information including a point in time, the number of times, a time, and a period related to playback of the at least one content on the at least one large display.

6. The content service providing method of claim 5, wherein the charging of the service fee for the content service comprises charging the at least one client the service fee for the content service further based on information related to playback of the at least one advertisement on the at least one large display, hardware information of the at least one large display, and location information of the at least one large display.

7. The content service providing method of claim 6, wherein information related to playback of the at least one advertisement on the at least one large display includes information related to an attribute of the at least one advertisement played back on the at least one large display, a point in time and a time at which the at least one advertisement is played back on the at least one large display, and a service fee for the at least one advertisement played back on the at least one large display.

8. The content service providing method of claim 6, wherein the location information of the at least one large display includes information related to a geographical location of the at least one large display and surrounding context of the at least one large display by the geographical location.

9. The content service providing method of claim 5, wherein the charging of the service fee for the content service further comprises paying at least a portion of the charged service fee to a creator of the at least one content.

10. The content service providing method of claim 5, wherein the charging of the service fee for the content service further comprises paying at least a portion of the charged service fee to a building owner of a building in which the at least one large display is installed when the at least one client is an advertiser of the at least one advertisement.

11. The content service providing method of claim 1, further comprising:
performing preprocessing for playing back the selected at least one content on the at least one large display, prior to providing the content service to the at least one client.

12. The content service providing method of claim 11, wherein the performing of the preprocessing comprises setting playback information that includes information on a point in time, a brightness, a feeling of color, a time, a speed, a volume, and a playback size related to playback of the selected at least one content.

13. The content service providing method of claim 12, wherein the setting of the playback information comprises setting the playback information based on information related to playback of the at least one advertisement on the at least one large display, hardware information of the at least one large display, or location information of the at least one large display.

14. A computer program recorded on a computer-readable recording medium to execute a content service providing method in conjunction with a computer system, wherein the content service providing method comprises:
storing and maintaining a plurality of contents playable back before or after at least one advertisement played back on at least one large display;
providing information related to the plurality of contents to at least one client;
selecting at least one content from among the plurality of contents in response to a selection input from the at least one client based on information related to the plurality of contents; and
providing a content service of allowing the selected at least one content to be played back on the at least one large display to the at least one client.

15. A content service providing system implemented as a computer system, the content service providing system comprising:
processor configured to execute computer-readable instructions,
wherein the at least one processor comprises:
a platform provider configured to store and maintain a plurality of contents playable back before or after at least one advertisement played back on at least one large display, and to provide information related to the plurality of contents to at least one client;
a content selector configured to select at least one content from among the plurality of contents in response to a selection input from the at least one client based on information related to the plurality of contents; and
a content service provider configured to provide a content service of allowing the selected at least one content to be played back on the at least one large display to the at least one client.
